(19) United States
(12) Patent Application Publication
(10) Pub. No.: US 2004/0151169 A1
(43) Pub. Date: Aug. 5, 2004

(54) High speed interface module

(76) Inventors: Andrew J. Nelson, Gloucester (CA); Simon G. Tardif, Ottawa (CA)

Correspondence Address: THOMAS JOHN MCDONALD, 10102 CEDAR HILL ROAD, QUINLAN, TX, 75474, US

(21) Appl. No.: 10/357,059

(22) Filed: Feb. 3, 2003

(51) Int. Cl. H04L 12/50; H04L 12/28

(52) U.S. Cl. 370/359; 370/419

(57) ABSTRACT

A data interface module for converting a data stream from one format to another format, including a data stream splitting module for receiving an input data stream in a first format and splitting the input data stream into parallel data streams, each of the parallel data streams being output from the data stream splitting module at a slower data rate than the input data stream is received thereby, and a linking module for receiving and recombining the parallel data streams to produce an output data stream in a second format having a higher data rate then the individual parallel data streams. Conveniently, the input data stream may include video data including successive groups of data, each group representing a portion of an image, the data stream splitting module being configured to direct successive groups to a different one of the parallel data streams and the output data stream may be an IEEE 1394.a compliant asynchronous packet stream.

### BACKGROUND OF INVENTION

The present invention relates to interface modules, and in particular to interface modules that are used to convert a high speed digital data stream from a first format to a second format.

The IEEE1394-1995 and supplemental 1394.a serial bus standards are becoming widely adopted for use in advanced electronics applications, and in particular digital video applications, that require high speed data transmission. The 1394 standards support asynchronous packet transmission, asynchronous stream transmission (added in 1394.a) and isochronous transmission. In a typical system in which digital video signals are transmitted from a camera, the data output from the camera is passed to a formatting module (often implemented using an FPGA) in which header information is added, and a single data stream from the formatting module is passed to a linking module from which the video data is output as an 1394 compliant isochronous stream. Although isochronous transmission does not guarantee data delivery, the use of an isochronous stream is useful in many constant bandwidth video/voice applications as it guarantees delivery time. The DCAM standard (1394-based Digital Camera Specification v1.30) specifies the use of isochronous transmission. One drawback of such isochronous 1394 digital video solutions is that they do not take advantage of the full bandwidth available on a 1394 bus.

It is therefore desirable to provide a high speed data interface that can receive high speed data from an input source such as a digital video camera and output high speed data that makes full use of the bandwidth available on an output link in a conveniently retrievable format.

### SUMMARY OF THE INVENTION

According to one aspect of the invention, there is provided a data interface module for converting a data stream from one format to another format, including a data stream splitting module for receiving an input data stream in a first format and splitting the input data stream into parallel data streams, each of the parallel data streams being output from the data stream splitting module at a slower data rate than the input data stream is received thereby, and a linking module for receiving and recombining the parallel data streams to produce an output data stream in a second format having a higher data rate then the individual parallel data streams. Conveniently, the input data stream may include video data including successive groups of data, each group representing a portion of an image, the data stream splitting module being configured to direct successive groups to a different one of the parallel data streams and the output data stream may be an IEEE 1394.a compliant asynchronous packet stream.

According to another aspect of the present invention, there is provided a data interface module for formatting a stream of raw image data into a stream of data packets, including data splitting and packeting means for splitting a received raw image data stream into first and second data streams, and dividing each of the first and second data streams up into a series of packets each having a data portion and to which the data splitting and packeting means adds an associated header to output a first stream and a second stream of packets, and linking means for receiving the first and second stream of packets and combining the first and second stream of packets to form a serial output stream including the packets from both the first and second stream of packets, the output stream having a data rate higher then each of the first and second stream of packets.

According to yet another aspect of the invention, there is provided a method for converting a data stream from one format to another format, including receiving an input data stream in a first format, splitting the input data stream into parallel data streams each having a slower data rate than the input data stream, and recombining the parallel data streams to produce an output data stream in a second format having a higher data rate then the individual parallel data streams.

### BRIEF DESCRIPTION OF THE DRAWINGS

FIG. 1 shows a block diagram overview of an interface module according to embodiments of the present invention.

FIG. 2 is an exemplary timing diagram showing data at various points in the interface module of FIG. 1.

FIG. 3 is functional block diagram of a splitter module of the interface module of FIG. 1.

FIG. 4 is a functional block diagram of a link module of the interface module of FIG. 1.

### DESCRIPTION OF THE PREFERRED EMBODIMENTS

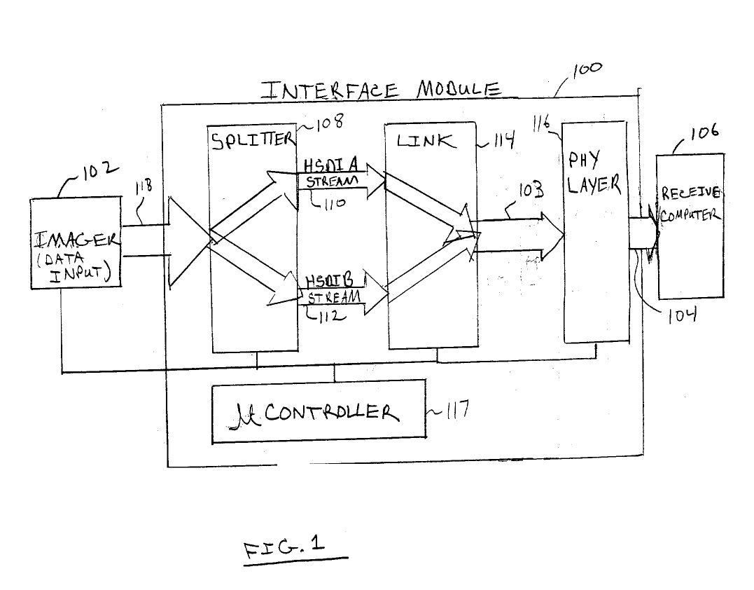

With reference to FIG. 1, a high speed data interface module 100, according to a preferred embodiment of the present invention, is shown in block diagram form. The interface module 100 is configured to receive a high speed data stream in a first format from a data input source such as a digital video camera or imager 102 and to output the data stream in a further format on an output interface bus such as an IEEE 1394.a compliant bus 104, for use by a receiving device such as computer 106. The interface module 100 includes a data splitting module 108 for splitting the input stream into two separate high speed data interface (HSDI) streams HSDI A and HSDI B and a link module 114 for recombining the two separate data streams into a single asynchronous data stream which is output, through a physical layer module 116, as an 1394.a compliant asynchronous data stream on bus 104. Overall operation of the camera 102, data splitting module 108 link module 114 and physical layer module 116 is coordinated by a microcontroller 117 that includes a processor, clock and persistent memory containing instructions for the processor.

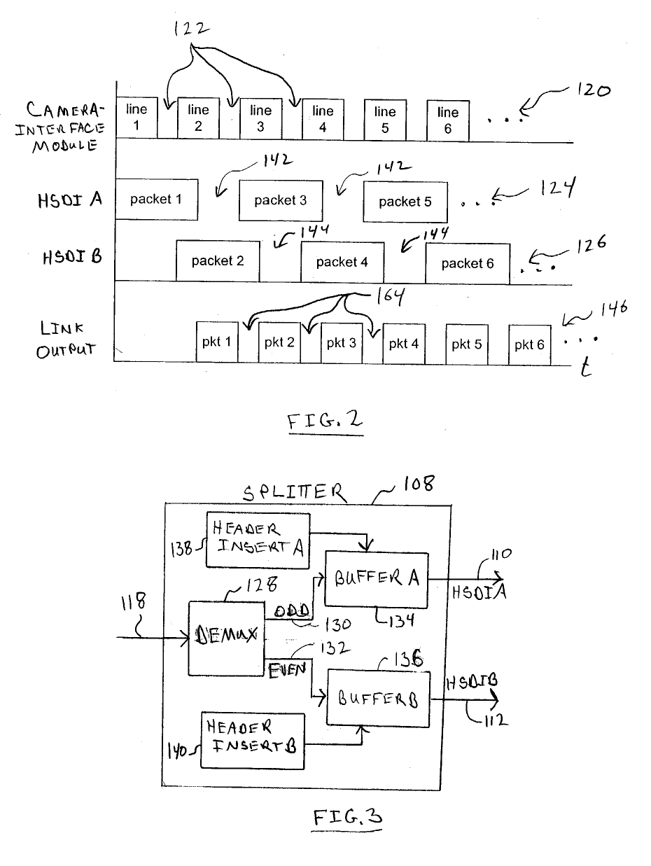

An overview of the data interface module 100 having been provided, the individual components of the system shown in FIG. 1 will now be described in greater detail. The IEEE 1394 a standard follows the OSI (Open Standard Interconnection) Model for networking. In the illustrated embodiment, the data interface module 100 is concerned with the two lowest layers of the OSI Model, the link layer and the physical layer. The splitter module 108 and link module 114 collectively provide link layer functionality, and the physical layer module 116 provides physical layer functionally. In the illustrated embodiment, the data source is digital imager 102 which outputs a digital video signal stream over a link 118 to the interface module 100. A representation of the video signal on link 118 is indicated generally by reference numeral 120. The video signal 120 includes a series of successive data groups (line 1, line 2, etc.), each group containing data corresponding to a line of video data as captured and transmitted by the imager 102. For example, for a imager having a frame resolution of 1024 by 1024 pixels, with each pixel represented by a byte of data, each data group line 1, line 2, etc. would include 1024 bytes representing one line of video in the frame, with a complete frame being transmitted with 1024 data groups. As indicated in FIG. 2, each of the data groups line 1, line 2, etc. are separated in time by a gap 122, which represents the horizontal interleave gap generated by most cameras.

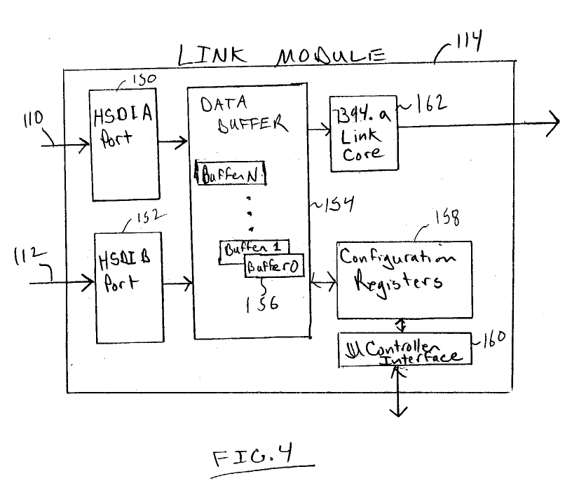

At data splitter module 108, the data on link 118 is received and divided into two distinct parallel data streams HSDI A and HSDI B, represented by rows 124 and 126, respectively in FIG. 2, each of which has a lower data transfer rate than the camera video signal 120, and which are output onto respective links 110 and 112. A functional block diagram representation of the data splitter module 108 is shown in FIG. 3. The video signal 120 on link 118 is provided to a switch or demultiplexer 128 where the video data is separated into two data streams, each of which is output on a separate link 130, 132. In a preferred embodiment, the demultiplexer 128 separates the video signal 120 on a line by line basis, with the data groups representing the odd numbered video lines line 1, line 3, line 5, etc. being output on link 130 to a first buffer A 134, and the data groups representing the even numbered video lines line 2, line 4, line 6, etc. being output on link 132 to a second buffer B 136.

The splitter module 108 includes header insert A logic 138 and header insert B logic 140 for adding an IEEE 1394.a compliant header to each of the data groups as they pass through buffer A 134 and buffer B 136, respectively to assemble data packets that each include the data from a corresponding data group plus a header. The inserted header is a standard 1394 packet header, and includes the following information: data length, channel number, speed of transmission and a synchronization field. Buffer A 134 and Buffer B 136 are each controlled to output data streams HSDI A and HSDI B, respectively, on links 110 and 112 at a data rate that corresponds to an acceptable data input rate for linking module 114. The data stream HSDI A includes a series of packets packet 1, packet 3, packet 5, etc. each of which includes the data in a respective data group line 1, line 3, line 5, etc., the 1394 header data inserted by header insert A logic 138 and CRC (cyclic redundancy checking) bits. Similarly, the data stream HSDI B includes a series of packets packet 2, packet 4, packet 6, etc. each of which includes the data in a respective data group line 2, line 4, line 6, etc. plus the header data inserted by header insert B logic 140 and CRC (cyclic redundancy checking) bits. Thus, the data stream HSDI A includes a series of successive packets, each of which corresponds to a successive odd numbered line of video, and the data stream HSDI B includes a series of successive packets, each of which corresponds to a successive even numbered line of video. As noted above, and as will be apparent from FIG. 2, the parallel data streams HSDI A and HSDI B, which preferably have the same data rate, each have a slower data rate than the camera video signal 120. In the illustrated embodiment time gaps 142 and 144 exist between successive packets in the streams HSDI A and HSDI B, respectively. In a preferred embodiment, the data splitter module 108 is implemented by means of a suitably configured field programmable gate array (FPGA).

The link module 114 recombines the HSDI A and HSDI B data streams to output an IEEE 1394.a compliant asynchronous data stream, indicated by generally by reference numeral 146 in FIG. 2, that has a higher data rate than each of the individual HSDI A and HSDI B data streams. The asynchronous data stream 146 is output, via physical layer module 116, on IEEE 1394.a bus 104. The recombined asynchronous data stream 146 includes successive packets pkt1, pkt2, pkt3, etc., each of which correspond to a successive line of video data line1, line 2, line 3, etc. plus the pocket header information added at splitter module 108. Data stream 146 may conveniently have a data rate that is just slightly higher than that of the imager 102 to compensate for the inserted packet headers. The asynchronous packets pkt1, pkt 2, etc. are separated by arbitration reset gaps 164, and perhaps some idle time.

Unlike conventional IEEE1394 video data solutions, the present invention outputs data using an asynchronous stream of packets as opposed to an isochronous stream of packets. Under IEEE 1394.a, asynchronous streaming of packets is similar to isochronous streaming of packets except that asynchronous streamed packets use a different arbitration scheme and have a lower priority than isochronous packets. In a normal 1394.a bus, asynchronous streamed packets have no guaranteed bandwidth, no guaranteed latency and unlike non-streaming asynchronous packet transmission, no delivery notification to guarantee delivery. However, in the present invention, the 1394.a bus 104 is dedicated to carrying data from the interface module 100 to a receiving device such as receive computer 106, and accordingly no protocol is required for guaranteeing bandwidth or latency. Unlike isochronous packet transmissions which can only be sent at the beginning of each 1394 cycle, asynchronous streams can be sent at any time during the 1394 cycle so long as the 1394.a bus 104 is otherwise idle. Thus, with a dedicated bus, asynchronous streaming requires less buffering and has generally lower latency (latency being the time that data is buffered while waiting for the bus) than a comparable isochronous transmission. Buffering requirements can be further reduced by using relatively small packet sizes in the asynchronous stream.

A functional block diagram of a preferred embodiment of the link module 114 is shown in FIG. 4. In one preferred embodiment, the link module 114 is implemented using a Texas Instruments™ TSB42AB4 ceLynx™ IEEE 1394.a link layer controller, and includes high speed data interface ports 150 and 152 for receiving the HSDI A and HSDI B data streams over links 110 and 112, respectively. The ports 150 and 152 are each connected to a highly configurable data buffer 154 that includes a plurality of buffers 0-n. Configuration of the data buffer is controlled by configuration registers 158 that are programmed, via microcontroller interface 160, by microcontroller 117. The data buffer 154 is connected to output data to a 1394.a link core 162, which in turn outputs the data packet stream 146 to the physical layer module 116.

The data buffer 154 is configured so that internal buffers 156 are associated with each HSDI port 150 and 152, with such buffers preferably each being larger than the packets that make up the HSDI A and HSDI B packet streams. When a complete packet is received in a buffer 156, the link core 162 sends the packet to physical layer module 116. Physical layer module 116 preferred by implemented by a commercially available IEEE 1394.a physical layer IC (by way of example only, IC's from the Texas Instruments™ TSB41 LVoX and TSB41AXX family of physical layer devices can be used). The physical layer module 116 functions in a manner well defined by the IEEE 1394 standard to take raw-data from the link module 114 and transmit it over IEEE1394.a bus 104, and it is responsible for bus arbitration and other low level functions. Once the physical layer module 116 receives and buffers a packet, it starts arbitrating for a time slot on the 1394.a bus 104 in which to send the packet. In particular, the module 116 looks for an arbitration reset gap 164, which it should detect almost immediately as: a) the bus 104 is dedicated to carrying data from the interface module 100 to a receiving device such as receive computer 106, so the full capacity of the bus 104 will be available for the asynchronous data steam that is being output by interface module 100; and b) the outgoing data rate of the combined asynchronous data stream from the link module 114 is faster than the data rates of each of the input HSDI A and HSDI B streams, so by the time the module 116 has received a complete packet, the previous packet will have been already output on the bus 104.

To allow the receive computer 106 to synchronize to the data stream on the 1394.a bus 104, a sightly different header is preferably used in each packet that corresponds to the first line of each frame. For example, in one preferred embodiment, header insertion at splitter module 108 is performed such that the first packet of each frame will have an “I” in the “SY” field of the 1394 header instead of an “O”. As the order and integrity of the video data is preserved through by interface module 100, the video image that is being transmitted from the camera 102 can be easily reconstructed at the receive computer 106. The data contained in the data fields of the respective packets 146 is raw pixel data. In the illustrated embodiment, the receive computer 108 includes a video adapter card appropriate for the data format output by imager 106, and PCI (Personal Computer Interface) card that is 1394 compatible and includes OHCI (Open Host Controller Interface) adaptors. The OHCI adapters are configured to pick the raw pixel data out of the received packets 146 and store into buffers in the receive computer 106 memory. When the OHCI adapter detects that it has received all the packets associated with a frame (which is indicated by detecting the different “SY” field in the first packet of each new frame), the buffered frame can be sent to the video adapter card without any further processing.

The embodiments of the invention described above provides an interface module that can receive a high speed digital video signal from an imager a camera and output an asynchronous packet stream that is IEEE 1394.a compliant, but not DCAM compliant. The configuration of the present invention can use a greater bandwidth of the IEEE 1394.a bus that would be used by a DCAM compliant solution.

The use of a data splitter module 108 (implemented by an FPGA in the described embodiments) to split the incoming data stream into two separate streams on a line by line basis permits the parallel streams to each be processed separately and recombined within the interface module 100 at a faster rate than if the incoming stream was not divided. For example, in the TI™ TSB42AB4, used in a preferred embodiment in the implementation of the link module 114, the maximum clock frequency of each of its two HSDI data ports (corresponding to ports 150, 152) is 24 MHz, permitting a maximum through-put of 24 MBps (mega-bytes/second) when only a single HSDI port is used. However, by using data splitter 108 to buffer and then direct the incoming data stream on an alternating line by line basis to the two HSDI ports 150, 152, the through-put of the interface module 100 can be increased well above the through-put of the individual HSDI ports.

It will be appreciated that the module 100 could be configured as an interface for data other than video data, and the incoming data split on some basis other than on a line by line basis. In some embodiments, the stream may be spit into more than two streams and subsequently recombined. Additionally, the module could be used with data formats other than that specified by IEEE 1394.a protocol. The functionality of the module 100 could be implemented in a number of ways other than the specific hardware embodiments described above, using microprocessors or other specifically designed application specific integrated circuits, programmable logic devices, software running on computer systems, or various combinations thereof.

As will be apparent to those skilled in the art in the light of the foregoing disclosure, many alterations and modifications are possible in the practice of this invention without departing from the spirit or scope thereof. The foregoing description is of the preferred embodiments and is by way of example, and is not to limit the scope of the invention as set forth in the following claims.

What is claimed is:

1. A data interface module for converting a data stream from one format to another format, comprising:
a data stream splitting module for receiving an input data stream in a first format and splitting the input data stream into parallel data streams, each of the parallel data streams being output from the data stream splitting module at a slower data rate than the input data stream is received thereby; and
a linking module for receiving and recombining the parallel data streams to produce an output data stream in a second format having a higher data rate then the individual parallel data streams.

2. The data interface module according to claim 1 wherein the input data stream includes video data including successive groups of data, each group representing a portion of an image, the data stream splitting module being configured to direct successive groups to a different one of the parallel data streams.

3. The data interface module of claim 1 wherein each group represents a line of video data.

4. The data interface of claim 1 wherein the output data stream is an IEEE 1394.a compliant asynchronous packet stream.

5. The data interface of claim 4 wherein the input data stream is digital video data.

6. The data interface of claim 1 wherein the data stream splitting module divides the input data stream into successive groups and adds an associated header to each of the groups to form packets, each header containing information about the packet that the header is associated with, and the data stream splitting module directs successive packets to a different one of the parallel data streams.

7. The data interface of claim 6 wherein the linking module alternatingly selects packets from the parallel data streams to produce the output data stream.

8. The data interface of claim 7 wherein the input data stream includes digital video image data comprising image frames, each frame having a plurality of lines, each of the packets containing data associated with reproducing a line of data, the data splitter being configured to identifiably mark the header of each packet that is associated with the first line of an image frame.

9. The data interface of claim 6 wherein the data splitter is implemented using an FPGA.

10. A data interface module for formatting a stream of raw image data into a stream of data packets, comprising:
data splitting and packeting means for splitting a received raw image data stream into first and second data streams, and dividing each of the first and second data streams up into a series of packets each having a data portion and to which the data splitting and packeting means adds an associated header to output a first stream and a second stream of packets; and
linking means for receiving the first and second stream of packets and combining the first and second stream of packets to form a serial output stream including the packets from both the first and second stream of packets, the output stream having a data rate higher then each of the first and second stream of packets.

11. The data interface module of claim 10 wherein the output data stream is an IEEE 1394.a complaint asynchronous packet stream.

12. The data interface module of claim 10 wherein the raw image data includes data representative of image frames, each frame including a plurality of successive lines, each packet containing the data associated with reproducing one of the lines.

13. The data interface of claim 12 wherein the data splitting and packeting means is configured to direct data associated with successive lines to different ones of the data streams in an alternating manner.

14. The data interface of claim 12 wherein the data splitting and packeting means is configured to identifiably mark the header of the first packet associated with the first line in each frame.

15. The data interface of claim 10 wherein the date splitting and packeting means includes an FPGA and the linking means includes an application specific integrated circuit.

16. A method for for converting a data stream from one format to another format, including:
receiving an input data stream in a first format, splitting the input data stream into parallel data streams each having a slower data rate than the input data stream; and
recombining the parallel data streams to produce an output data stream in a second format having a higher data rate then the individual parallel data streams.

17. The method of claim 16 including splitting the input data stream into parallel data streams each made up of successive packets each including data from the input data stream and an associated header, the output data stream being an asynchronous packet stream.

18. The method of claim 17 wherein each packet includes data representative of a single line of a video image frame, the video image frame including a plurality of lines.

19. The method of claim 18 including identifiably marking the header of the first packet associated with the first line in each image frame.

20. The method of claim 18 wherein the input data stream is split on a line by line basis, with data representative of successive lines being directed to a different one of the parallel data streams.
